(19) United States
(12) Patent Application Publication
(10) Pub. No.: US 2024/0116495 A1
(43) Pub. Date: Apr. 11, 2024

(54) PARKING ASSIST SYSTEM, PARKING ASSIST METHOD, AND A NON-TRANSITORY COMPUTER-READABLE STORAGE MEDIUM

(71) Applicant: TOYOTA JIDOSHA KABUSHIKI KAISHA, Aichi (JP)

(72) Inventors: Naoki KANADA, Toyota-shi (JP); Daisuke SUZUKI, Okazaki-shi (JP)

(21) Appl. No.: 18/465,980

(22) Filed: Sep. 13, 2023

(30) Foreign Application Priority Data
Oct. 11, 2022 (JP) 2022-163032

(51) Int. Cl. B60W 30/06; G05D 1/00; G06V 20/58

(52) U.S. Cl. CPC B60W 30/06; G05D 1/0016; G06V 20/586; B60W 2556/45

(57) ABSTRACT

A parking assistance system includes a remote control device that transmits a signal for remotely controlling the own vehicle from outside the vehicle in response to an operation by the user, a surrounding sensor that acquires surrounding information that is information about a target object, a processor specifies a parking spot in which the own vehicle is parked based on the surrounding information, a function of setting a target position inside the parking spot, a function of setting a route to the target position, and a processor having a function of moving the own vehicle along the route to reach the target position and waiting in response to the first signal. After the own vehicle reaches the target position, the remote control device transmits a second signal for correcting the position of the own vehicle, and the processor moves the own vehicle in response to the second signal.

### BACKGROUND OF THE INVENTION

### 1. Field of the Invention

The present invention relates to a parking assist system, a parking assist method, and a non-transitory computer-readable storage medium for parking an own vehicle in a predetermined parking spot.

### 2. Description of the Related Art

There has been proposed a parking assist system capable of executing an automated parking process (automated parking control) in which a parking spot in which an own vehicle can be parked is detected using a sensor mounted on the own vehicle and the own vehicle is moved to the parking spot to be parked (for example, refer to Patent Document 1).

A processor (an arithmetic device mounted on the own vehicle) of the parking assist system (hereinafter referred to as a “conventional system”) described in Patent Document 1 determines a target parking position based on information acquired from a sensor. The target parking position is a position of the own vehicle in a state in which the own vehicle is parked (for example, a position of a center of gravity of the own vehicle). The processor sets a route from the current location (a point outside the parking spot) to the target parking position. Next, the driver (user) gets out of the own vehicle and operates a remote control device outside the own vehicle. The processor moves the own vehicle along the route based on a signal transmitted from the remote control device. The processor stops the own vehicle at the target parking position. The processor shifts the ignition switch to the off state after shifting the shift position of the own vehicle to the parking position and activating the parking brake.

### SUMMARY OF THE INVENTION

The conventional system described above completes the automated parking process when the own vehicle reaches the target parking position. In a state where the automated parking process is completed, for example, there is a case where the own vehicle slightly protrudes from the frame line of the parking spot. In addition, for example, the wheels of the own vehicle may be slightly riding on the wheel clasp. In such a situation, according to the conventional system, when the user desires to correct the position of the own vehicle, the user first connects (performs authentication work) the remote control device to the processor via a wireless communication line. Next, the user operates the remote control device to restart the own vehicle (shift the ignition switch to the ON state). Then, the user operates the remote control device to move the own vehicle. As described above, when the conventional system is employed, the work of correcting the parking position of the own vehicle is complicated.

An object of the present invention is to provide a parking assist system capable of easily correcting a parking position of the own vehicle.

In order to achieve the above object, a parking support system (1) according to the present invention includes a remote control device (60) for transmitting a signal for remotely controlling a vehicle (V) from the outside of the vehicle in response to an operation by a user, a surrounding sensor (21 22) for acquiring surrounding information relating to a target object existing around the vehicle, a processor (10) mounted on the vehicle, a function for specifying a parking spot (PS) in which the vehicle is parked on the basis of the surrounding information, a function for setting a target position (TP) inside the parking spot, a function for setting a route (R) to the target position, and a function for moving the vehicle along the route according to a first signal (S1) transmitted from the remote control device A processor having a function of reaching and waiting is provided. The remote control device transmits a second signal (S2) for correcting the position of the own vehicle in response to the user's operation after the own vehicle reaches the target position, and the processor moves the own vehicle in response to the second signal when the processor receives the second signal.

In the parking assistance system according to the present invention, the processor waits while the control system (the drive device, the braking device, the steering device, and the like) of the own vehicle is activated from the time when the own vehicle reaches the target position. Then, from this state, the user can start the remote operation and correct the position of the own vehicle without restarting the control system of the own vehicle. According to the parking assistance system of the present invention, the user can easily correct the parking position of the own vehicle.

In the parking assistance system according to an aspect of the present invention, the user can ride on the own vehicle at the target position and operate the own vehicle to correct the parking position of the own vehicle.

According to this configuration, the processor waits in a state where the own vehicle reaches the target position. Therefore, the user can immediately start a driving operation for correcting the position of the own vehicle without restarting the own vehicle by getting into the own vehicle.

Further, the parking assistance method according to the present invention includes a step executed by each device constituting the parking assistance system.

### BRIEF DESCRIPTION OF THE DRAWINGS

FIG. 1 is a block diagram of a parking assistance system according to an embodiment of the present invention.

FIG. 2 is a plan view illustrating a process of moving the own vehicle to a target position.

FIG. 3 is an example of an image displayed on a smartphone.

FIG. 4 is a plan view illustrating a process of correcting the position of the own vehicle.

FIG. 5 is a flow chart of a program executed by an arithmetic device of the parking assistance ECU.

FIG. 6 is a flowchart of a program executed by an arithmetic device of the smartphone.

### DESCRIPTION OF THE EMBODIMENTS

### (Overview)

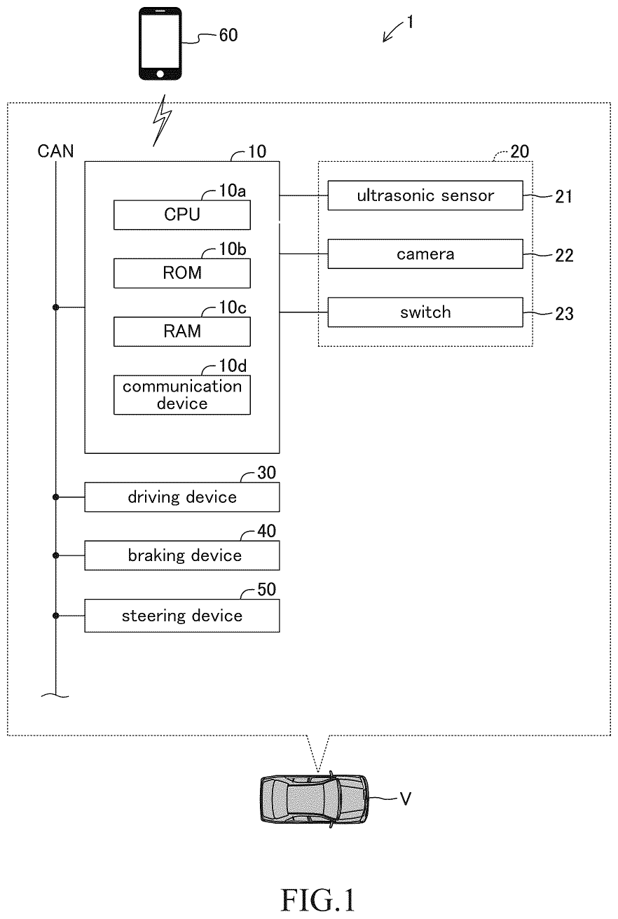

As illustrated in FIG. 1, the parking assist system 1 according to an embodiment of the present invention is mounted on a vehicle V (hereinafter, referred to as an “own vehicle”) having an automatic driving function. The parking assist system 1 has a function for automatically parking the own vehicle in the parking spot PS (autonomous parking function).

### (Specific Configuration)

As illustrated in FIG. 1, the parking assist system 1 includes a parking assist ECU10, onboard sensor 20, a driving device 30, a braking device 40, a steering device 50, and a smart phone 60.

The parking assist ECU10 is a processor mounted on the own vehicle. The parking assist ECU 10 includes a microcomputer including a CPU10a, ROM10b, RAM10c and the like. The parking assist ECU10 further includes a communication device 10d for wirelessly communicating with the smart phone 60 described later.

The parking assist ECU10 is connected to another ECU (for example, an ECU in a driving device 30, a braking device 40, and a steering device 50, which will be described later) via a CAN (Controller Area Network).

The onboard sensor 20 includes a surrounding sensor that acquires information regarding an object that exists in the surroundings of the own vehicle. For example, the onboard sensor 20 includes an ultrasonic sensor 21 as the surrounding sensor and a camera 22.

The ultrasonic sensor 21 intermittently radiates an ultrasonic wave to a peripheral region of the own vehicle, and receives an ultrasonic wave (reflected wave) reflected by a three-dimensional object. The ultrasonic sensor 21 recognizes the distance between the own vehicle and the three-dimensional object, the relative position (orientation) of the three-dimensional object with respect to the own vehicle, and the like on the basis of the time from the transmission of the ultrasonic wave to the reception of the reflected wave. The ultrasonic sensor 21 transmits the recognition result to the parking assist ECU10.

The camera 22 includes an imaging device and an image analysis device. The imaging device is, for example, a digital camera including an imaging element such as CCD (charge coupled device) or CIS (CMOS image sensor). The imaging device is installed in a front portion, a rear portion, a left side portion, and a right side portion of the own vehicle. The imaging device captures an image of the peripheral area of own vehicle at predetermined frame rates, and acquires the image data. The imaging device transmits each image data to the image analysis device. The image analysis device analyzes the acquired image data, and acquires information for an object that exists around the own vehicle from the image data. For example, the image-analysis device recognizes shape and color of a wall or fence that separates the parking spot, the road surface pattern, and the like, and transmits the recognition result to the parking assist ECU10.

Further, the onboard sensor 20 includes a switch 23. The switch 23 is an operation device for requiring the driver to start automated parking control, which will be described later. The switch 23 includes, for example, normally-open switch device of a push button type. The parking assist ECU10 monitors the on/off status of the switch 23.

The driving device 30 applies a driving force to the driving wheels in the wheels (the left front wheels, the right front wheels, the left rear wheels, and the right rear wheels). The driving device 30 includes an engine ECU, an internal combustion engine, a transmission, a driving force transmission mechanism that transmits driving force to wheels, and the like. The internal combustion engine includes an actuator that drives a throttle valve. The engine ECU acquires information (control signal) representing a target driving force from another ECU (parking assist ECU10), and drives an actuator of the internal combustion engine based on the information. In this way, the driving force applied to the drive wheels is controlled. The driving force generated by the internal combustion engine is transmitted to the drive wheels via the transmission and the driving force transmission mechanism. In addition, the engine ECU acquires information (control signal) regarding the shift position of the transmission from another ECU, and drives the actuator of the transmission based on the information. In this way, the shift position of the transmission is controlled.

If the vehicle to which the parking assist system 1 is applied is a hybrid electric vehicle (HEV), the engine ECU can control the driving force of the vehicle generated by either or both of the “internal combustion engine and the electric motor” as the vehicle driving source. If the vehicle to which the parking assist system 1 is applied is a battery electric vehicle (BEV), an electric motor ECU that controls the driving force of the vehicle generated by an “electric motor” as a vehicle driving source may be used instead of the engine ECU.

The braking device 40 applies a braking force to the wheels (brake discs). The braking device 40 includes a brake ECU, a brake caliper, and the like. The brake caliper includes an actuator that presses the brake pad against the brake disc. The brake ECU acquires information (control signal) indicating a target braking force from another ECU, and drives an actuator of the brake caliper based on the information. In this way, the braking force applied to the wheel (brake disc) is controlled.

The steering device 50 controls the steering angles of the steering wheels (the left front wheel and the right front wheel). The steering device 50 includes a steering ECU, a steering mechanism, and the like. The steering mechanism is a link mechanism including a knuckle arm, a tie rod, and the like. The steering device 50 further includes an actuator that drives the steering mechanism to change the steering angle. The steering ECU acquires information (control signal) indicating a target steering angle from another ECU, and drives the actuator based on the information. In this way, the steering angle of the steered wheels is controlled.

The smartphone 60 functions as a remote control device that remotely controls the own vehicle by executing a predetermined program. That is, the smartphone 60 transmits signals (for example, a first signal S1, a second signal S2, and the like, which will be described later) for remotely operating the own vehicle in response to an operation by the user. These signals are transmitted to the parking assist ECU10 via a predetermined wireless communication line.

### (Parking Assist Function)

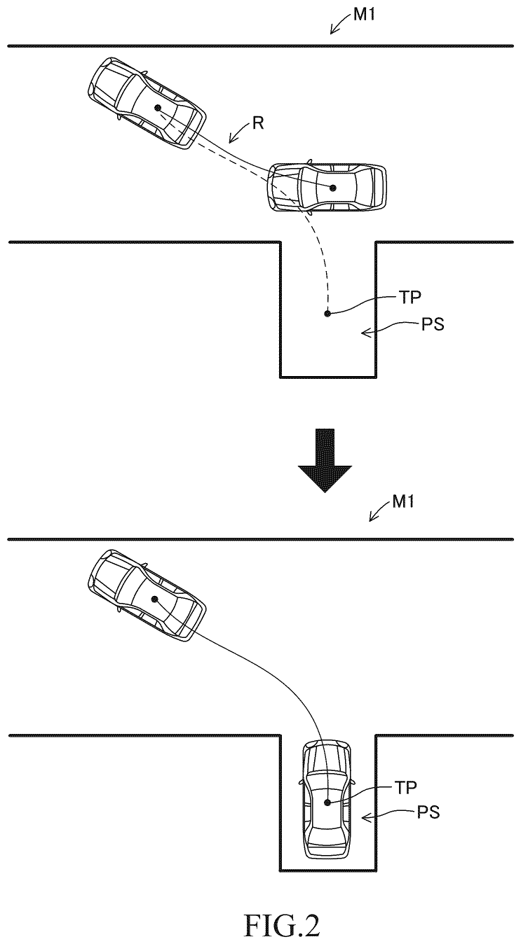

The driver temporarily stops the own vehicle in the vicinity of the parking spot PS in which the own vehicle is to be parked, and presses the switch 23. Accordingly, the parking assist ECU10 of the parking assist system 1 starts executing a program P1 (parking assist program) described in detail later. That is, the parking assist ECU 10 starts the automated parking control for automatically parking the own vehicle in the parking spot PS. Specifically, when the parking assist ECU10 detects that the switch 23 has been pressed, the parking assist ECU 10 acquires, from the ultrasonic sensor 21 and the camera 22, information indicating the object present in the surroundings of the own vehicle. The parking assist ECU10 specifies the parking spot at which the own vehicle is parked based on the information acquired from the ultrasonic sensor 21 and the camera 22. Then the parking assist ECU 10 generates map M1 including the parking spot illustrated in FIG. 2 based on the information. The map M1 is a plan view showing the position and attitude of the own vehicle with respect to the parking-spot PS.

Next, the parking assist ECU10 sets a target position TP at which the own vehicle is parked in the parking spot PS based on the map M1. The target position TP is a position of the center of gravity of the own vehicle when it is assumed that the own vehicle is parked in the parking spot PS with providing a space of a predetermined width or more around the own vehicle. Next, the parking assist ECU10 sets (calculates) a route R (a target trajectory of the center of gravity of the own vehicle) on which the own vehicle can be moved to the target position TP while avoiding contact with obstacles. Next, the parking assist ECU10 sets a control signal pattern (time-series data of control signals supplied to the driving device 30, the braking device 40, and the steering device 50, respectively) for moving the own vehicle along the route R.

The parking assist ECU10 reflects the target position TP and the route R in the map M1. The parking assist ECU10 displays the map M1 on an onboard display device (not shown). The user confirms that the displayed route R, the target position TP, and the like are correct.

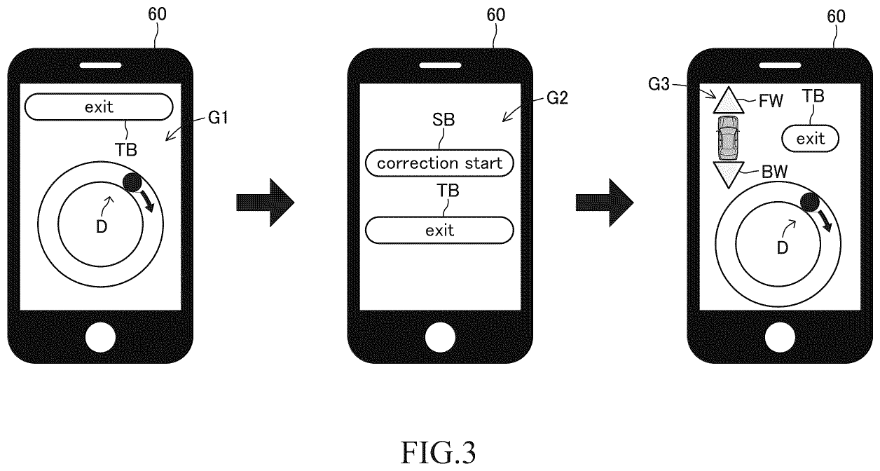

Next, the user activates a program P2 (remote control program) installed in advance in the smartphone 60. The program P2 is a program for causing the smartphone 60 to execute a remote control step for transmitting a signal for remotely controlling the own vehicle in response to an operation by the user, in order to cause the parking assist ECU10 to execute the program P1. When the program P2 is started to be executed, the smartphone 60 displays an initial-image (not shown). In this situation, the user connects the smartphone 60 to the parking assist ECU10 via a wireless communication line. In other words, the user performs a predetermined authentication operation (login ID and password-entry). When the authenticating operation is completed, the smartphone 60 displays an image G1 shown in FIG. 3. The image G1 includes a dial-D, which is an image for moving the own vehicle along the route R. The image G1 includes an end-button TB, which is an image for ending the automated parking control.

The user gets out of the own vehicle and operates the smartphone 60. When the user traces the dial D outside the vehicle with his or her finger, the smartphone 60 transmits a first signal S1 indicating that the own vehicle is allowed to travel along the route R. The first signal S1 is transmitted while the user is tracing the dial D with his or her finger. When the user stops tracing the dial D with his or her finger, the first signal S1 is not transmitted. When receiving the first signal S1, the parking assist ECU10 controls the own vehicle in accordance with the control signal pattern. As a result, the own vehicle moves along the route R. The parking assist ECU10 temporarily stops the own vehicle when the first signal S1 is not received. For example, when a pedestrian, a bicycle, or the like approaches the own vehicle, the user can temporarily stop the vehicle by stopping tracing the dial D with his or her finger. The parking assist ECU10 sequentially acquires recognition result regarding the objects present around the own vehicle from the ultrasonic sensor 21 and the camera 22 while causing the own vehicle to move along the route R. When detecting an obstacle that disturbs the movement of the own vehicle based on the recognition result, the parking assist ECU 10 temporarily stops the own vehicle. In this situation, the parking assist ECU10 causes the smartphone 60 to display images indicating the presence of an obstacle. In this context, the parking assist ECU10 is unable to receive the first signal S1. Therefore, even if the user operates the dial D, the own vehicle does not move. When the obstacle moves away from the own vehicle and the own vehicle is allowed to travel, the parking assist ECU10 is allowed to receive the first signal S1. When the duration of the condition in which the obstacle does not move and the own vehicle cannot travel along the route R exceeds the threshold value, the parking assist ECU10 determines whether or not a new route R that allows the own vehicle to reach the target position TP while avoiding to contact with the obstacle can be set. When a new route R can be set, the parking assist ECU10 temporarily displays the new route R on the smartphone 60. Then, the parking assist ECU10 can receive the first signal S1. The user can move the own vehicle along the new route R by operating the dial D. The direction in which the dial D is traced (clockwise or counterclockwise) is not limited. That is, when the user traces the dial D clockwise or counterclockwise, the parking assist ECU10 advances the control of the driving device or the like in accordance with the control signal pattern.

The parking assist ECU10 temporarily stops the own vehicle when the own vehicle reaches the target position TP. Further, the parking assist ECU10 shifts the shifting position SP to the parking position. In this state, the ignition switch of the own vehicle remains in the ON state. That is, when the own vehicle reaches the target position TP, the parking assist ECU10 causes the own vehicle to stand by without ending the automated parking control (the automated parking control is put into the standby status). In this standby mode, the parking assist ECU10 and the smartphone 60 can continue to communicate with each other. The parking assist ECU10 transmits a signal RS indicating that the own vehicle has reached the target position TP (the own vehicle has been stored in the parking spot PS). Upon receiving the signal RS, the smartphone 60 displays the image G2 shown in FIG. 3. The image G2 includes a correction start button SB which is an image for starting an operation for correcting the position of the own vehicle, and an exit button TB which is an image for ending the automated parking control.

When the user taps the correction start button SB, the smartphone 60 displays the picture G3 shown in FIG. 3. The image G3 includes a forward button FW and a reverse button BW, which are images for selecting a moving direction (forward or reverse) of the own vehicle. Further, the image G3 includes a dial D similar to the image G1. In addition, the image G3 includes an exit-button TB. First, the user taps the forward button FW or the reverse button BW to select a direction in which the vehicle moves. The smartphone 60 transmits a signal DS representing the selected direction. The parking assist ECU10 changes the shift-position SP according to the signal DS. That is, when the forward button FW is tapped, the parking assist ECU10 shifts the shift position SP to the forward position. On the other hand, when the reverse button BW is tapped, the parking assist ECU10 shifts the shift position SP to the reverse position.

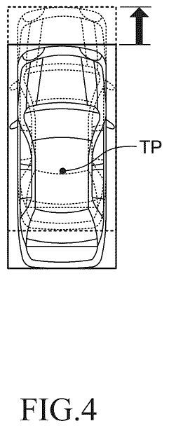

When the user traces the dial D with his or her finger, the smartphone 60 transmits a second signal S2 for moving the own vehicle in the selected direction. The parking assist ECU10 controls the driving device 30 to move the own vehicle while the second signal S2 is received. The parking assist ECU10 holds the steering angle θ at “0°”. That is, the parking assist ECU10 moves the own vehicle straight in the selected direction (forward or backward) (see FIG. 4).

When the vehicle reaches the desired position, the user taps an exit button TB. The smartphone 60 transmits a signal TS for ending the automated parking control, and ends executing the programming P2. Upon receiving the signal TS, the parking assist ECU10 shifts the shifting position SP to the parking position, activates the parking brake, and then shifts the ignition switch to the off-state. In this way, the position of the own vehicle is corrected by remote control.

Note that while the smartphone 60 is displaying the image G2, the user may correct the position of the own vehicle by tapping the correction start button SB and then riding on the own vehicle and operating the operating device (accelerator pedal, brake pedal, shift lever, steering, etc.) of the own vehicle.

The parking assist system 1 terminates the execution of the automated parking control when a predetermined end-condition is satisfied during the execution of the automated parking control. Specifically, as described above, when the user taps the exit button TB, the end-condition is satisfied. In addition, when the user starts operating the operation device of the own vehicle by getting into the own vehicle, the end-condition is satisfied. When the duration of the state in which the communication between the parking assist ECU10 and the smartphone 60 is interrupted (the state in which the user does not operate the smartphone 60) exceeds the threshold value, the end-condition is satisfied.

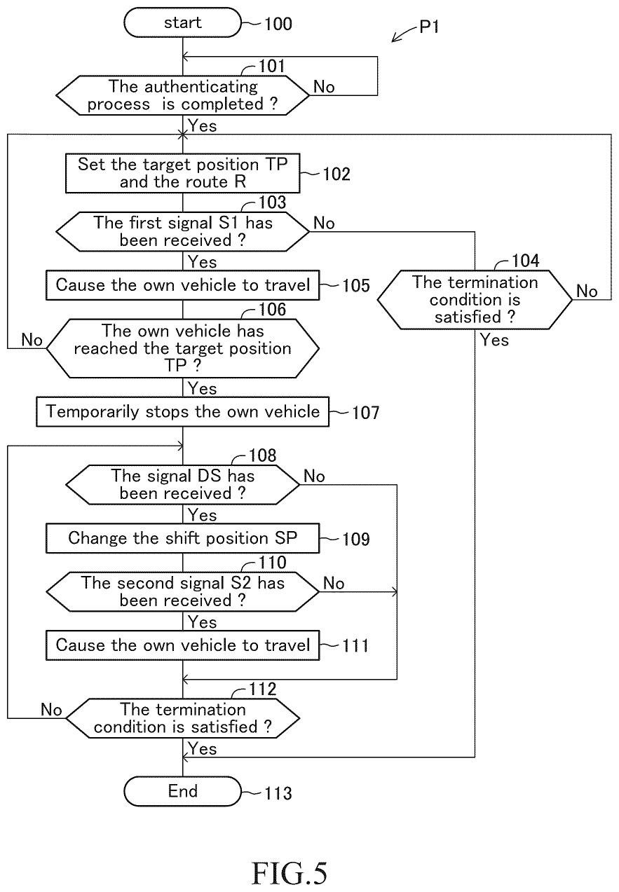

Next, referring to FIG. 5, a process (program P1) executed by a CPU10a (hereinafter referred to as “CPUa”) of the parking assist ECU10 will be specifically described.

Upon detecting that the switch 23 has been pressed, the CPUa starts executing the program P1 from step 100 and proceeds the process to step 101.

In step 101, the CPUa determines whether the authenticating process of the smartphone 60 is completed. In the case where the authenticating process is completed (101:Yes), the CPUa proceeds the process to step 102. On the other hand, in the case where the authenticating process is not completed (101:No), the CPUa returns the process to step 101.

In step 102, the CPUa sets the target position TP. Further, the CPUa sets the route R, or corrects the route R so as to avoid to contact with a newly detected obstacle, based on the information acquired from the onboard sensor 20. Then, the CPUa proceeds the process to step 103.

In step 103, the CPUa determines whether the first signal S1 has been received from the smartphone 60. In the case where the CPUa receives the first signal S1 (103:Yes), the process proceeds to step 105. On the other hand, in the case where the CPUa has not received the first signal S1 (103:No), the process proceeds to step 104.

In step 104, the CPUa determines whether the end-condition is satisfied. In the case where the end-condition is satisfied (104:Yes), the CPUa proceeds the process to step 113 to end executing the program P1. In the case where the end-condition is not satisfied (104:No), the CPUa returns the process to step 102.

In step 105, the CPUa controls the driving device and the like in accordance with the control signal pattern to cause the own vehicle to move along the route R. Then, the CPUa proceeds the process to step 106.

In step 106, the CPUa determines whether or not the own vehicle has reached the target position TP. In the case where the own vehicle has reached the target position TP (106:Yes), the CPUa proceeds the process to step 107. On the other hand, in the case where the own vehicle has not yet reached the target position TP (106:No), the CPUa returns the process to step 102.

In step 107, the CPUa transmits a signal RS and temporarily stops and stands by the own vehicle at the target position TP. Note that the ignition switch is held in the ON state. Then, the CPUa proceeds the process to step 108.

In step 108, CPUa determines whether a signal DS has been received from the smart phone 60. In the case where the CPUa receives the signal DS (108:Yes), the process proceeds to step 109. In the case where the CPUa does not receive the signal DS (108:No), the process proceeds to step 112, which will be described later.

The CPUa changes the shift position SP according to the signal DS in step 109. Then, CPUa proceeds the process to step 110.

In step 110, the CPUa determines whether the second signal S2 is received from the smartphone 60. In the case where the CPUa receives the second signal S2 (110:Yes), the process proceeds to step 111. On the other hand, in the case where the CPUa has not received the second signal S2 (110:No), the process proceeds to step 112.

In step 111, the CPUa controls the driving device or the like to move (forward or backward) the own vehicle. Then, the CPUa proceeds the process to step 112.

In step 112, the CPUa determines whether the end-condition is satisfied. In the case where the end-condition is satisfied (112:Yes), the CPUa proceeds the process to step 113 to end executing the program P1. In the case where the end-condition is not satisfied (112:No), the CPUa returns to step 108.

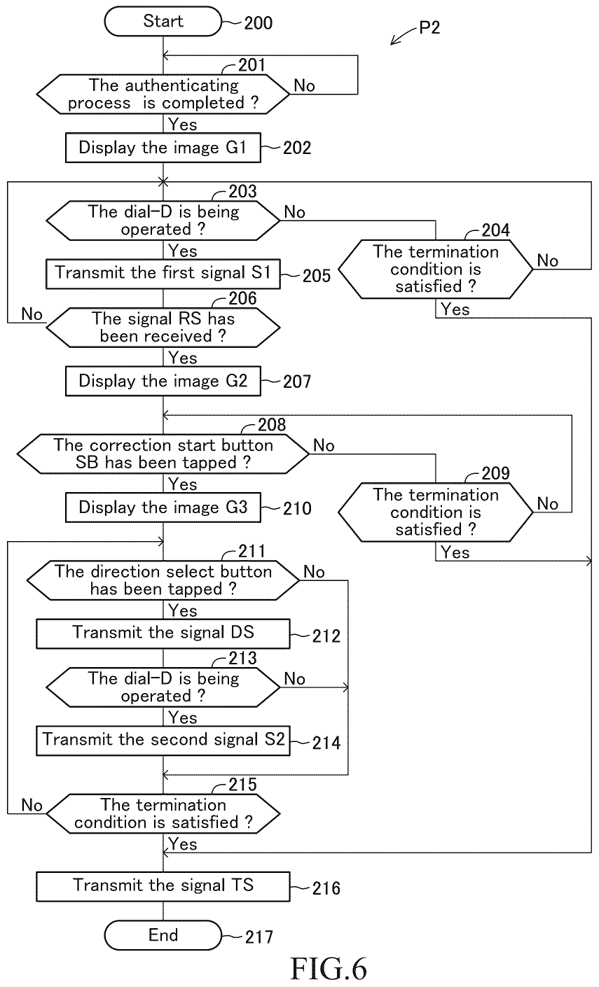

Next, referring to FIG. 6, a process (program P2) executed by an arithmetic unit (hereinafter referred to as “CPUb”) of the smartphone 60 will be specifically described.

The program P2 is installed by being downloaded from a predetermined server computer to the smartphone 60. When the user taps the icon for executing the program P2 displayed on the display device of the smartphone 60, the CPUb starts executing the program P2 from step 200 and proceeds the process to step 201.

In step 201, the CPUb determines whether the authentication process with the parking assist ECU10 has been completed. In the case where the authentication process is completed (201;Yes), the CPUb proceeds the process to step 202. On the other hand, in the case where the authentication process is not completed (201:No), the CPUb returns the process to step 201.

The CPUb displays the image G1 in step 202. Then, the CPUb proceeds the process to step 203.

In step 203, the CPUb determines whether or not the dial-D is being operated. If the dial D is operated (203:Yes), the CPUb proceeds the process to step 205. On the other hand, in the case where the dial D is not operated (203:No), the CPUb proceeds the process to step 204.

In step 204, the CPUb determines whether the end-condition is satisfied. In the case where the end-condition is satisfied (204:Yes), the CPUb proceeds the process to step 216, which will be described later. In the case where the end-condition is not satisfied (204:No), the CPUb returns the process to step 203.

In step 205, the CPUb transmits the first signal S1. Then, the CPUb proceeds the process to step 206.

In step 206, the CPUb determines whether the signal RS has been received. In the case where the CPUb receives the signal RS (206:Yes), the process proceeds to step 207. In the case where the CPUb has not received the signal RS (206:No), the process returns to step 203.

The CPUb displays the image G2 in step 207. Then, the CPUb proceeds the process to step 208.

The CPUb determines whether the correction start button SB has been tapped in step 208. In the case where the correction start button SB has been tapped (208:Yes), the CPUb proceeds the process to step 210. On the other hand, in the case where the correction start button SB has not been tapped (208:No), the CPUb proceeds the process to step 209.

In step 209, the CPUb determines whether the end-condition is satisfied. In the case where the end-condition is satisfied (209:Yes), the CPUb proceeds the process to step 216, which will be described later. In the case where the end-condition is not satisfied (209:No), the CPUb returns the process to step 208.

The CPUb displays the image G3 in step 210. Then, the CPUb proceeds the process to step 211.

The CPUb determines whether a direction select button (the forward button FW or the reverse button BW) has been tapped in step 211. In the case where the direction select button is tapped (211:Yes), the CPUb proceeds the process to step 212. On the other hand, in the case where the direction select button is not tapped (211:No), the CPUb proceeds the process to step 215.

The CPUb transmits the signal DS corresponding to the direction indicated by the tapped direction select button in step 212. Then, the CPUb proceeds the process to step 213.

In step 213, the CPUb determines whether or not the dial-D is operated. In the case where the dial D is operated (213:Yes), the CPUb proceeds the process to step 214. On the other hand, in the case where the dial D is not operated (213:No), the CPUb proceeds the process to step 215.

CPUb transmits the second signal S2 in step 214. Then, the CPUb proceeds the process to step 215.

In step 215, the CPUb determines whether the end-condition is satisfied. In the case where the end-condition is satisfied (215:Yes), the CPUb proceeds the process to step 216 to end executing the program P2. On the other hand, in the case where the end-condition is not satisfied (215:No), the CPUb returns the process to step 211.

### (Effect)

According to the parking assist system 1, the parking assist ECU10 puts the own vehicle into the standby state without ending the automated parking control while keeping the ignition switch in the ON state after the own vehicle reaches the target position TP. Then, when the own vehicle is in the standby state, the user can start remote control without restarting the own vehicle and correct the position of the own vehicle. Therefore, according to the parking assist system 1, the user can easily correct the parking position of the own vehicle.

The present invention is not limited to the above-described embodiment, and various modifications can be adopted within the scope of the present invention.

### (Modification 1)

The above-described parking assist system 1 is configured to move the own vehicle from the target position to forward direction or backward direction by the remote control. In addition, the parking assist system 1 may be configured to be able to move the own vehicle from the target position to the left direction or the right direction by the remote operation.

The vehicle V may be an autonomous vehicle.

What is claimed is:

1. A parking assist system comprising:
a remote control device for transmitting a signal for remotely operating an own vehicle from the outside of the own vehicle in response to an operation by the user;
a surrounding sensor for acquiring surrounding information which is information regarding an object existing around the own vehicle; and
a processor mounted on the own vehicle, the processor having a function for specifying a parking spot in which the own vehicle is parked based on the surrounding information, a function for setting a target position inside the parking spot, a function for setting a route to the target position, a function for the vehicle to reach the target position by moving the own vehicle along the route according to a first signal transmitted from the remote control device, and a function for the own vehicle to wait at the target position; wherein
the remote control device transmits a second signal for correcting the position of the own vehicle in response to an operation by the user after the own vehicle reaches the target position, and
the processor is configured to move the own vehicle in response to the second signal when the second signal is received.

2. The parking assist system according to claim 1, wherein the user is able to ride on the own vehicle at the target position and operate the own vehicle to correct the position of the own vehicle.

3. A parking assist method comprising:
a first remote control step for a remote control device to transmit a first signal for moving an own vehicle along a predetermined route, the first signal being transmitted in response to an operation of the remote control by a user;
a surrounding information acquiring step for acquiring a surrounding information which is an information regarding an object existed around the own vehicle;
a parking step executed by a processor mounted on the vehicle, the parking step including a process for specifying a parking spot based on the surrounding information, a process for setting a target position inside the parking spot based on the surrounding information, a process for setting a route to the target position, a process for reaching the own vehicle to the target position by moving the own vehicle along the route in response to the first signal, and a process for causing the own vehicle to wait at the target position;
a second remote control step for the remote control device to transmit a second signal for correcting the position of the own vehicle after the own vehicle reaches the target position, the second signal being transmitted in response to the operation of the remote control device by the user, and
a position correcting step for causing the processor to execute a process for moving the own vehicle in response to the second signal.

4. A non-transitory storage medium storing a parking assist program causing a computer provided in the own vehicle to execute an automated parking step for causing the own vehicle to park at a predetermined parking spot by moving the own vehicle in response to a signal transmitted from the remote control device, wherein the automated parking step including:
a surrounding information acquiring step for acquiring a surrounding information which is an information regarding an object existed around the own vehicle;
a parking step including a process for specifying a parking spot based on the surrounding information, a process for setting a target position inside the parking spot based on the surrounding information, a process for setting a route to the target position, a process for reaching the own vehicle to the target position by moving the own vehicle along the route in response to a first signal transmitted from a remote control device, and a process for causing the own vehicle to wait at the target position; and
a position correcting step for moving the own vehicle in response to a second signal for correcting the position of the own vehicle transmitted from the remote control device when receiving the second signal after the own vehicle has reached the target position.
